(19) United States
(12) Patent Application Publication
(10) Pub. No.: US 2026/0155857 A1
(43) Pub. Date: Jun. 4, 2026

(54) TUNING METHOD FOR AN ANTENNA DEVICE

(71) Applicant: MEDIATEK INC., Hsinchu City (TW)

(72) Inventors: Yen-Liang Chen, Hsinchu City (TW); Po-Chung Hsiao, Hsinchu City (TW); Chun-Hsiang Chen, Hsinchu City (TW); Chin-Wei Hsu, Hsinchu City (TW)

(21) Appl. No.: 18/967,704

(22) Filed: Dec. 4, 2024

(51) Int. Cl. H04B 1/40; H01Q 5/335; H04B 1/04

(52) U.S. Cl. CPC H04B 1/40; H01Q 5/335; H04B 1/04; H04B 2001/0416

(57) ABSTRACT

A tuning method for an antenna device is provided. The antenna device includes an antenna, an impedance matching tuner (IMT) and a radio frequency front end (RFFE). The antenna device is coupled to a radio frequency transmitter/receiver (RF transceiver), In a characterization stage, the antenna device is characterized to obtain several mapping data between the first load impedances for transmitting (TX) frequencies and the second load impedances for receiving (RX) frequencies, corresponding to several configurations of the IMT and several operating conditions of the antenna device. In a tuning stage, the first load impedances at a current configuration of the IMT are estimated. The first load impedances are mapped to obtain the second load impedances at the current configuration based on the mapping data. The IMT is tuned based on the first load impedances and the second load impedances at the current configuration of the IMT.

### TECHNICAL FIELD

The disclosure relates to an antenna device, and in particular relates to a tuning method for the antenna device.

### BACKGROUND

As the progress of wireless communication technology, electronic devices (e.g., smart phones, laptop computers, etc.) are equipped with antenna devices to perform communication in a wireless manner. In one antenna device, an impedance matching tuner (IMT) is utilized to match impedances between an antenna and a radio frequency front end (RFFE) of the antenna device.

In order to achieve optimal matching under various conditions, impedance measurements are obtained at different transmitting (TX) frequencies, and the measuring result is provided to set the IMT. However, when only the impedance at TX frequencies is taken into account, the effects of RX elements of the antenna device may be neglected, and the IMT setting may not be optimized.

In view of the above issues, it is desirable to have an improved tuning mechanism for the IMT in the antenna device, which can jointly consider the impedances at both TX frequencies and RX frequencies.

### SUMMARY

According to one embodiment of the present disclosure, a tuning method for an antenna device is provided. The antenna device includes an antenna, an impedance matching tuner (IMT) and a radio frequency front end (RFFE). The antenna device is coupled to a radio frequency transmitter/receiver (RF transceiver), the antenna is coupled to RFFE through the IMT, and the RFFE is coupled to the RF transceiver. The tuning method comprises the following steps. In a characterization stage, the antenna device is characterized to obtain a set of mapping data between a set of first load impedances and a set of second load impedances of the antenna device associated with a plurality of configurations of the IMT and a plurality of operating conditions of the antenna device. The first load impedances correspond to a set of transmitting (TX) frequencies and the second load impedances correspond to a set of receiving (RX) frequencies. In a tuning stage, the first load impedances at a current configuration of the IMT are estimated. The first load impedances with the mapping data are mapped to obtain the second load impedances at the current configuration of the IMT. The IMT is tuned based on each of the first load impedances corresponding to the TX frequencies and each of the second load impedances corresponding to the RX frequencies, at the current configuration of the IMT.

### BRIEF DESCRIPTION OF THE DRAWINGS

FIG. 1 is a circuit diagram of an antenna device 1000 according to an embodiment of the present disclosure.

FIG. 2A is a schematic diagram illustrating the forward signal provided by the RF transceiver 400.

FIG. 2B is a schematic diagram illustrating the reverse signal provided by the RF transceiver 400.

FIG. 3 is a schematic diagram illustrating the setting for the IMT 200 based on both Tx and Rx conditions.

FIGS. 4A and 4B are flow diagrams of the tuning method for the setting for the IMT 200 according to an embodiment of the present disclosure.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### DETAILED DESCRIPTION

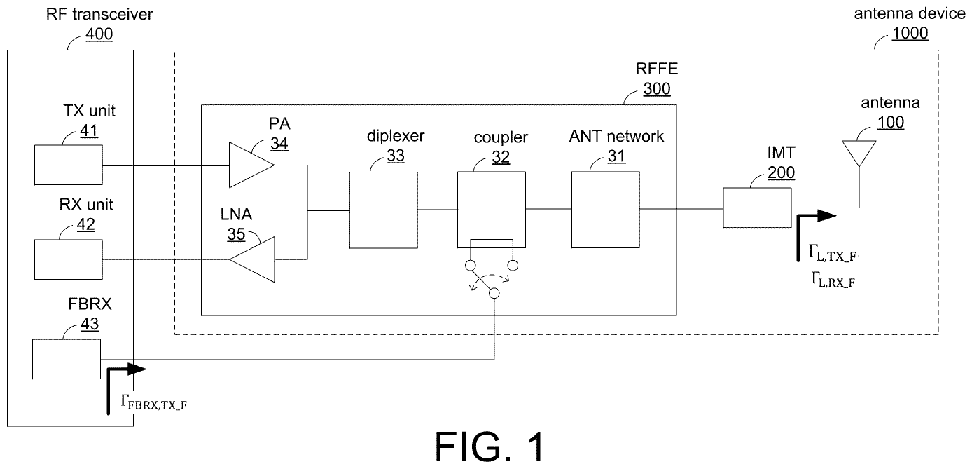

FIG. 1 is a circuit diagram of an antenna device 1000 according to an embodiment of the present disclosure. As shown in FIG. 1, the antenna device 1000 includes an antenna 100, an impedance matching tuner (IMT) 200 and a radio frequency front end (RFFE) 300. Furthermore, the antenna device 1000 is coupled to a radio frequency transmitter/receiver (RF transceiver) 400.

The RFFE 300 includes an antenna network (ANT network) 31, a coupler 32, a diplexer 33, a power amplifier (PA) 34 and a low noise amplifier LNA 35. The antenna 100 is coupled to the antenna network 31 of the RFFE 300 through the IMT 200. The antenna network 31, the coupler 32 and the diplexer 33 are coupled in series.

The RF transceiver 400 includes a transmitting unit (TX unit) 41, a receiving unit (RX unit) 42 and a feedback receiver (FBRX) 43. The TX unit 41 is coupled to the diplexer 33 of the RFFE 300 through the PA 34. The RX unit 42 is coupled to the diplexer 33 through the LNA 35. The FBRX 43 is coupled to the coupler 32 of the RFFE 300.

In operation, the IMT 200 is used to match impedances between the antenna 100 and the RFFE 300. The IMT 200 has a set of code-words for performing the impedance matching. The antenna device 1000 may execute a tuning method to adjust the setting of the code-words of the IMT 200. The tuning method includes a first stage and a second stage. The first stage is a “characterization stage”, and the second stage is a “tuning stage”.

In the characterization stage, the antenna 100, the IMT200 and the RFFE 300 are characterized to obtain a “performance data”. The performance data may include a set of indicators for evaluating TX performance and RX performance of the antenna device 1000. For example, the indicators of the performance data may indicate e.g., a TX power, a RX power and a reference-signal-received-power (RSRP) of the antenna 100.

The IMT 200 has a plurality of configurations (also referred to as “tuner states”), including e.g., a reference configuration and several current configurations. In the reference configuration, the IMT 200 is operating in a bypass mode. The current configuration refers to a configuration with which the IMT 200 is operating currently. Furthermore, the antenna device 1000 has a plurality of operating conditions, including e.g., a free space condition and an interference condition. In the free space condition, the antenna device 1000 is free of any interference. On the other hand, in the interference condition, the antenna device 1000 may be disposed adjacent to some materials that may cause interference on the antenna device 1000. The performance data of the antenna 100, the IMT200 and the RFFE 300 are characterized for each of the configurations of the IMT 200 and each of the operating conditions of the antenna device 1000.

Furthermore, in the characterization stage, the IMT 200, the RFFE 300 and the FBRX 43 are characterized to obtain a “characterization data”. The characterization data may include a set of S-parameters of the IMT 200, the RFFE 300 and the FBRX 43. The S-parameters may include parameters of S₂₁ and S₂₂, etc. In addition, the characterization data may include impedance of the FBRX 43, which is referred to as “first impedance”. The characterization data of the IMT 200, the RFFE 300 and the FBRX 43 are characterized for each of the configurations of the IMT 200 and each of the operating conditions of the antenna device 1000.

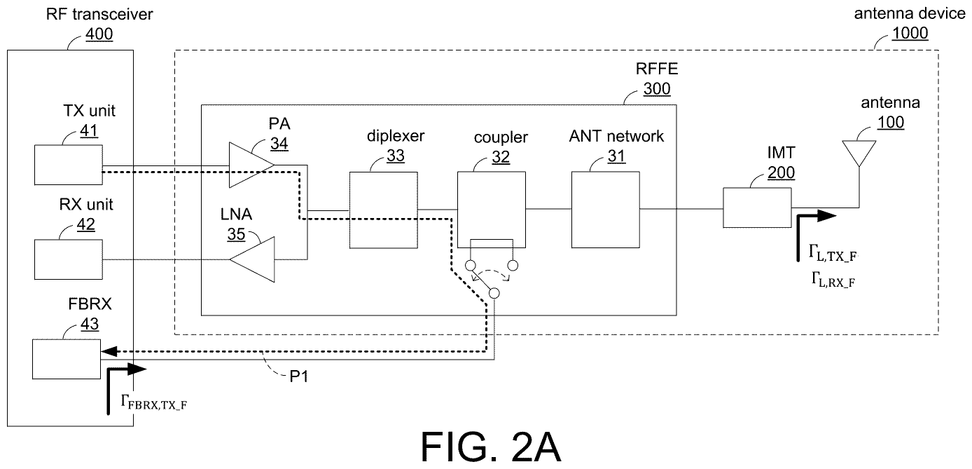

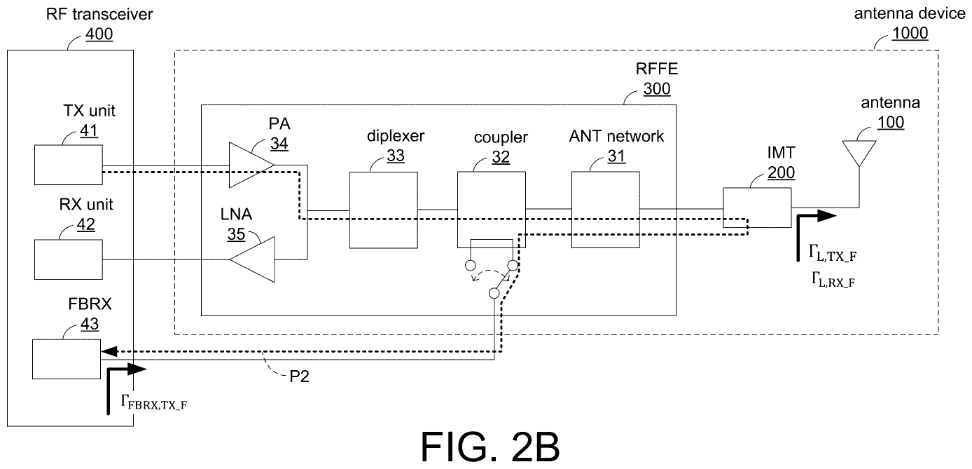

The characterization data of the IMT 200, the RFFE 300 and the FBRX 43 in conjunction with the impedance of the FBRX 43, which are characterized in the characterization stage, are used to estimate a load impedance Γ_{L,TX_F} for the antenna 100 at each of transmitting (TX) frequencies. The load impedance Γ_{L,TX_F} at each TX frequency is referred to as “first load impedances”. The load impedance Γ_{L,TX_F} may be estimated with the characterization data and the impedance of the FBRX 43 in a closed-form equation, which utilizes a forward signal and a reverse signal to calculate reflection coefficients of the antenna load, as will be described in the following paragraphs with reference to FIGS. 2A and 2B.

FIG. 2A is a schematic diagram illustrating the forward signal provided by the RF transceiver 400. Referring to FIG. 2A, in the RF transceiver 400, the TX unit 41 may be configured to generate the forward signal, and the forward signal is conveyed through a first path P1 in the RF transceiver 400 and the antenna device 1000. The first path P1 is a “forward path” which starts from the TX unit 41, passes through the PA 34, the diplexer 33 and the coupler 32, and ends at the FBRX 43. The forward signal is sent by the TX unit 41 and then back to the FBRX 43 through the first path P1.

Then, referring to FIG. 2B, which is a schematic diagram illustrating the reverse signal provided by the RF transceiver 400. Similar to the forward signal, the reverse signal is also generated by the TX unit 41. The reverse signal is conveyed through a second path P2 in the RF transceiver 400 and the antenna device 1000. The second path P2 is a “reverse path” which starts from which starts from the TX unit 41, passes through the PA 34, the diplexer 33, the coupler 32, the ANT network 31, the IMT 200, and back to the antenna network 31 and the coupler 32, and then ends at the FBRX 43.

S-parameters associated with the antenna 100 (e.g., parameters of S₂₁ and S₂₂, etc.) may be calculated based on the relation between the forward signal and the reverse signal in amplitude and phase. Then, the calculated S-parameters, in conjunction with the impedance of the FBRX 43 at each TX frequency (symbolized as “Γ_{FBRX,TX_F}”), are used to estimate the load impedance Γ_{L,TX_F} of the antenna 100 at each TX frequency. In one example, the coupler 32 may sample the forward signal and the reverse signal so as to generate the S-parameters and other characterization data.

In addition, the calculated S-parameters (e.g., parameters of S₂₁ and S₂₂), in conjunction with the performance data (e.g., the indicator RSRP which evaluates RX performance), are used to estimate the load impedance Γ_{L,TX_F} of the antenna 100 at each RX frequency. For example, an indicator RSRPₖ and parameters of S_{21,k} and S_{22,k} with an index “k” are provided. Among all configurations of the IMT 200, the index “k” denotes a current configuration of the antenna device 1000. Likewise, another indicator RSRPⱼ and parameters of S_{21,j} and S_{22,j} with an index “j” are provided. The index “j” denotes the reference configuration of the IMT 200. Given the indicator RSRPₖ and parameters of S_{21,k} and S_{22,k} with the index “k” and the indicator RSRPⱼ and parameters of S_{21,j} and S_{22,j} with the index “j”, the load impedance Γ_{L,RX_F} at the RX frequency may be calculated based on the following equation (1):

$$\frac{{RSRP}_{k}}{{RSRP}_{j}} = \frac{{RTG}_{k}}{{RTG}_{j}} = \frac{\frac{{\vert {S}_{21 , k} \vert}^{2}}{{\vert 1 - ( {S}_{22 , k} \times {Γ}_{L , RX\_F} ) \vert}^{2}}}{\frac{{\vert {S}_{21 , j} \vert}^{2}}{{\vert 1 - ( {S}_{22 , j} \times {Γ}_{L , RX\_F} ) \vert}^{2}}} \qquad eq . ( 1 )$$

In equation (1), a relative transducer gain (RTG), denoted by “RTGₖ” with the index “k”, may be represented by a relation function of parameters of S_{21,k} and S_{22,k} and the load impedance Γ_{L,RX_F}. Likewise, a relative transducer gain denoted by “RTGⱼ” with the index “j”, may be represented by a relation function of parameters of S_{21,j} and S_{22,j} and the load impedance Γ_{L,RX_F}.

Several load impedances Γ_{L,RX_F} at several corresponding RX frequencies, each of which has been obtained from equation (1), are referred to as “second load impedances”. On the other hand, several load impedances Γ_{L,TX_F} at several corresponding TX frequencies, each of which has been obtained based on the characterization data (e.g., the S-parameters) and the impedance of the FBRX 43, are referred to as “first load impedances”. Then, a set of mapping data between the load impedances Γ_{L,TX_F} at the TX frequencies and the load impedances Γ_{L,RX_F} at the RX frequencies are obtained.

One entry of the set of mapping data, which is between one load impedance Γ_{L,TX_F} and a corresponding load impedance Γ_{L,RX_F}, may be an offset value or a gain value. For example, the load impedance Γ_{L,TX_F} may be summed with an offset value OF to form the corresponding load impedance Γ_{L,RX_F}, as shown in equation (2-1):

$${Γ}_{L , RX\_F} = {Γ}_{L , TX\_F} + OF \qquad eq . ( 2 - 1 )$$

Alternatively, the load impedance Γ_{L,TX_F} may be multiplied with a gain value G to form the corresponding load impedance Γ_{L,RX_F}, as shown in equation (2-2):

$${Γ}_{L , RX\_F} = {Γ}_{L , TX\_F} \times G \qquad eq . ( 2 - 2 )$$

The set of mapping data represent mapping relationships between the load impedance Γ_{L,TX_F} and the load impedance Γ_{L,RX_F} corresponding to various configurations of the IMT 200 and various operating conditions of the antenna device 1000.

Subsequent to the characterization stage of the tuning method, the antenna device 1000 executes the tuning stage in which the setting of the code-words of the IMT 200 is adjusted, corresponding to the current configuration of the IMT200. In the tuning stage, firstly, the impedance of the FBRX 43 of the RF transceiver 400, which corresponds to the current configuration of the IMT 200 and the operating condition of the antenna device 1000, is measured.

Furthermore, the load impedance Γ_{L,TX_F} at each TX frequency, which corresponds to the current configuration of the IMT 200 and the operating condition of the antenna device 1000, is estimated. For example, the load impedance Γ_{L,TX_F} may be estimated based on the impedance of the FBRX 43 (i.e., the impedance of the FBRX 43 has been measured earlier in the tuning stage) and the characterization data (i.e., the characterization data, including e.g., the S-parameters, have been obtained in the characterization stage).

Moreover, given the estimated load impedance Γ_{L,TX_F} as the above, the load impedance Γ_{L,RX_F} at each RX frequency, which corresponds to the current configuration of the IMT 200 and the operating condition of the antenna device 1000, can be obtained based on the set of mapping data. That is, for the current configuration of the IMT 200 and the operating condition of the antenna device 1000, the load impedance Γ_{L,TX_F} may be mapped to obtain the load impedance Γ_{L,RX_F} based on the set of mapping data (where the mapping data has been obtained in the characterization stage). For example, according to equation (2-1), the load impedance Γ_{L,TX_F} may be summed with the offset value OF to obtain the load impedance Γ_{L,RX_F}. Alternatively, according to equation (2-2), the load impedance Γ_{L,TX_F} may be multiplied with the gain value G to obtain the load impedance Γ_{L,RX_F}.

Given the estimated load impedance Γ_{L,TX_F} and the mapped load impedance Γ_{L,RX_F} as the above, the setting of the code-words of the IMT 200 corresponding to the current configuration of the IMT 200 and the operating condition of the antenna device 1000, may be adjusted based on joint consideration of the load impedance Γ_{L,TX_F} and the impedance Γ_{L,RX_F}. Since the load impedance Γ_{L,TX_F} and the impedance Γ_{L,RX_F} are both taken into consideration, performance degradation caused by RX elements sharing the same antenna can be fairly analyzed, when adjusting the setting of the code-words of the IMT 200.

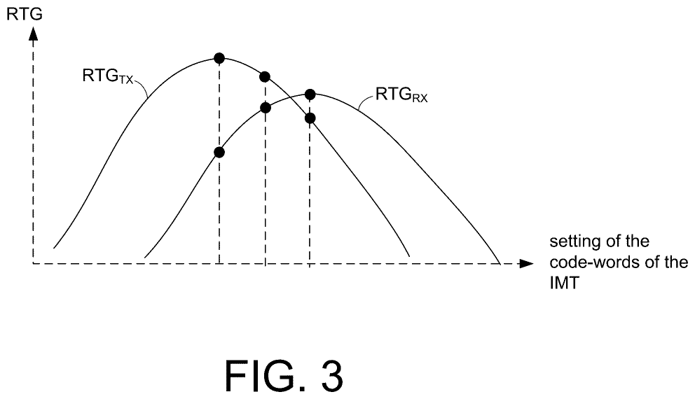

FIG. 3 is a schematic diagram illustrating the setting for the IMT 200 based on both Tx and Rx conditions. Referring to FIG. 3, the setting of the code-words of the IMT 200 is adjusted based on joint consideration of the load impedance Γ_{L,TX_F} and the impedance Γ_{L,RX_F}, corresponding to the current configuration of the IMT 200 and the operating condition of the antenna device 1000. The relative transducer gain RTG₀ for the IMT 200 is set based on joint consideration of the relative transducer gain RTG_{TX} at the TX frequency and the relative transducer gain RTG_{RX} at the RX frequency. For example, the relative transducer gain RTG₀ for the IMT 200 is set as a summation of the relative transducer gain RTG_{TX} and the relative transducer gain RTG_{RX} weighted by weighting factor α and weighting factor β respectively, as shown in equation (3):

$${RTG}_{0} = α {RTG}_{TX} + β {RTG}_{RX} \qquad eq . ( 3 )$$

In other examples, the relative transducer gain RTG_{TX} and the relative transducer gain RTG_{RX} may be multi-dimensional vectors. Correspondingly, the weighting factor α and weighting factor β in equation (3) are expanded to a first weight vector and a second weight vector, so as to weight the vector-formed relative transducer gain RTG_{TX} and the relative transducer gain RTG_{RX}.

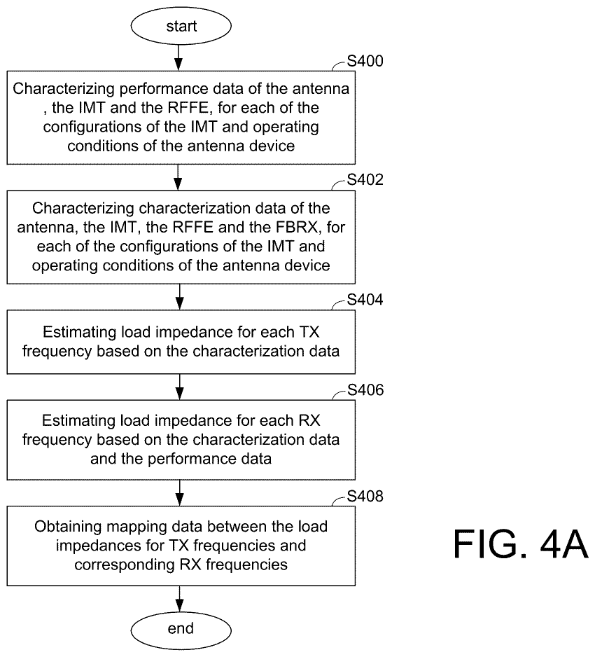

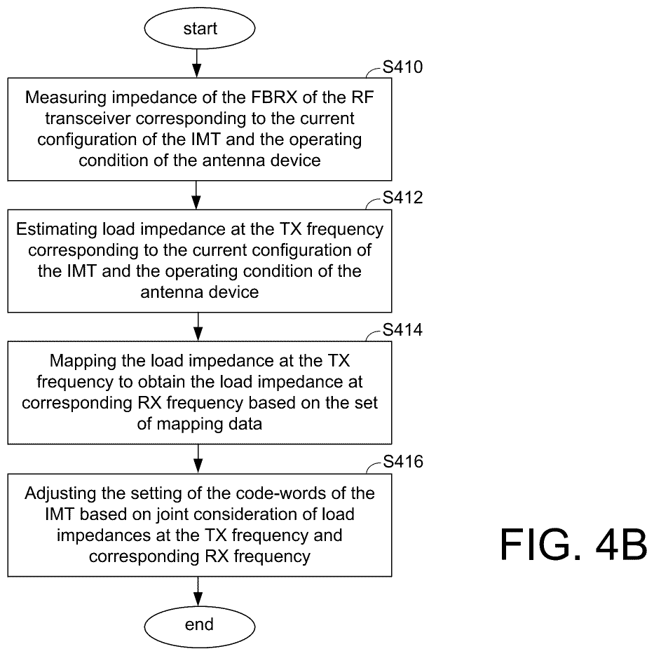

FIGS. 4A and 4B are flow diagrams of the tuning method for the setting for the IMT 200 according to an embodiment of the present disclosure. Referring to FIG. 4A, which illustrates steps of the characterization stage of the tuning method. Firstly, step S400 is executed: the performance data of the antenna 100, the IMT200 and the RFFE 300 are characterized, for each of the configurations of the IMT 200 and each of the operating conditions of the antenna device 1000. Then, step S402 is executed: the characterization data of the antenna 100, the IMT200, the RFFE 300 and the FBRX 43 of the RF transceiver 400 are characterized, for each of the configurations of the IMT 200 and each of the operating conditions of the antenna device 1000.

Then, step S404 is executed: the load impedance Γ_{L,TX_F} for each TX frequency is estimated based on the characterization data. Then, step S406 is executed: the load impedance Γ_{L,RX_F} for each RX frequency is estimated based on the performance data and the characterization data. Then, step S408 is executed: the set of mapping data between the load impedance Γ_{L,TX_F} and the corresponding load impedance Γ_{L,RX_F} are obtained.

Next, referring to FIG. 4B, which illustrates steps of the tuning stage of the tuning method. Firstly, step S410 is executed: impedance of the FBRX 43 of the RF transceiver 400 corresponding to the current configuration of the IMT 200 and the operating condition of the antenna device 1000, is measured. Then, step S412 is executed: load impedance Γ_{L,TX_F} at each TX frequency, corresponding to the current configuration of the IMT 200 and the operating condition of the antenna device 1000, is estimated.

Then, step S414 is executed: for the current configuration of the IMT 200 and the operating condition of the antenna device 1000, the load impedance Γ_{L,TX_F} is mapped to obtain the load impedance Γ_{L,RX_F} based on the set of mapping data (the mapping data are obtained in step S408 of FIG. 4A). Then, step S416 is executed: the setting of the code-words of the IMT 200 corresponding to the current configuration of the IMT 200 and the operating condition of the antenna device 1000 may be adjusted based on joint consideration of the load impedance Γ_{L,TX_F} and the impedance Γ_{L,RX_F}.

In view of various examples provided in the former paragraphs, the tuning method of the present disclosure utilizes runtime load impedance measurement to determine the setting for the IMT 200. Mapping data between the load impedance Γ_{L,TX_F} and the impedance Γ_{L,RX_F} are obtained in the characterization stage. Then, in the tuning stage, the impedance Γ_{L,RX_F} for the current configuration of the IMT 200 is obtained based on the mapping data. Thereafter, when adjusting the setting of the code-words of the IMT 200 at the current configuration, both the load impedance Γ_{L,TX_F} and the impedance Γ_{L,RX_F} for the current configuration of the IMT 200 are taken into consideration. Hence, performance degradation caused by RX elements sharing the same antenna can be fairly analyzed.

It will be apparent to those skilled in the art that various modifications and variations can be made to the disclosed embodiments. It is intended that the specification and examples be considered as exemplars only, with a true scope of the disclosure being indicated by the following claims and their equivalents.

What is claimed is:

1. A tuning method for an antenna device, wherein the antenna device includes an antenna, an impedance matching tuner (IMT) and a radio frequency front end (RFFE), and the antenna device is coupled to a radio frequency transmitter/receiver (RF transceiver), the antenna is coupled to RFFE through the IMT, and the RFFE is coupled to the RF transceiver, and the tuning method comprising:
in a characterization stage:
characterizing the antenna device to obtain a set of mapping data between a set of first load impedances and a set of second load impedances of the antenna device associated with a plurality of configurations of the IMT and a plurality of operating conditions of the antenna device, wherein the first load impedances correspond to a set of transmitting (TX) frequencies and the second load impedances correspond to a set of receiving (RX) frequencies;
and
in a tuning stage:
estimating the first load impedances at a current configuration of the IMT;
mapping the first load impedances with the mapping data to obtain the second load impedances at the current configuration of the IMT; and
tuning the IMT based on each of the first load impedances corresponding to the TX frequencies and each of the second load impedances corresponding to the RX frequencies, at the current configuration of the IMT.

2. The tuning method of claim 1, wherein an entry of the set of mapping data is an offset value between one of the set of first load impedances and a corresponding one of the set of second load impedances.

3. The tuning method of claim 1, wherein an entry of the set of mapping data is an gain value for one of the set of first load impedances with respect to a corresponding one of the set of second load impedances.

4. The tuning method of claim 1, wherein the operating conditions of the antenna device at least comprise a free space condition and an interference condition.

5. The tuning method of claim 1, wherein in the characterization stage, the step of characterizing the antenna device comprising:
characterizing a performance data of the antenna, the IMT and the RFFE at each of the configurations of the IMT at each of the operating conditions of the antenna device; and
characterizing the IMT, the RFFE and a feedback receiver (FBRX) of the RF transceiver to obtain a characterization data.

6. The tuning method of claim 5, wherein the step of characterizing the antenna device further comprising:
estimating the first load impedances at each of the configurations of the IMT at each of the operating conditions of the antenna device based on the characterization data; and
estimating the second load impedances at each of the configurations of the IMT at each of the operating conditions of the antenna device based on the characterization data and the performance data.

7. The tuning method of claim 6, wherein the second load impedances are estimated based on at least one relation function of the characterization data and the performance data.

8. The tuning method of claim 7, wherein the at least one relation function is associated with a reference configuration and the current configuration of the IMT at the same one of the operating conditions.

9. The tuning method of claim 5, wherein the characterization data comprise a set of S-parameters of the IMT, the RFFE and the FBRX, wherein the S-parameters comprise parameters of S₂₁ and S₂₂.

10. The tuning method of claim 5, wherein the performance data comprise a set of indicators of a TX performance and a RX performance of the antenna.

11. The tuning method of claim 10, wherein the indicators of the RX performance comprise a reference-signal-received-power (RSRP).

12. The tuning method of claim 1, wherein in the tuning stage, before the step of estimating the first load impedances, further comprising:
measuring a set of first impedances of a feedback receiver (FBRX) corresponding to the TX frequencies.

13. The tuning method of claim 12, the antenna device is coupled to a radio frequency transmitter/receiver (RF transceiver) which includes the FBRX and a transmitting unit, and the tuning method further comprising:
utilizing the transmitting unit to provide a forward signal and a reverse signal through a first path and a second path respectively; and
utilizing the FBRX to receive the forward signal and the reverse signal,
wherein the first path starts from the transmitting unit, passes through the coupler and back to the FBRX, and the second path starts from the transmitting unit, passes through the coupler and the IMT, and back to the FBRX.

14. The tuning method of claim 13, further comprising:
utilizing the coupler to sample the forward signal and the reverse signal so as to generate the characterization data.

15. The tuning method of claim 1, wherein in the tuning stage, the step of tuning the antenna device comprising:
setting a set of code-words of the IMT based on the first load impedances and the second load impedances at the current configuration of the IMT.

16. The tuning method of claim 15, wherein the code-words are set based on a first weight vector of a first relative-transducer-gain (RTG) associated with the first load impedances and a second weight vector of a second RTG associated with the second load impedances, wherein each of the first weight vector and the second weight vector comprises at least one weight value.
